(19) United States
(12) Patent Application Publication
(10) Pub. No.: US 2004/0011941 A1
(43) Pub. Date: Jan. 22, 2004

(54) Medical equipment stabilizer weight assembly

(76) Inventors: Aaron Roepke, Oklahoma City, OK (US); Falon D. Fuller, Oklahoma City, OK (US); James Steve Ruse, Oklahoma City, OK (US)

Correspondence Address: DAVID G. HENREY, 7th Floor, 900 Washington Avenue, P.O. Box 1470, Waco, TX, 77603-1470, US

(21) Appl. No.: 10/200,614

(22) Filed: Jul. 22, 2002

(51) Int. Cl. F16M 13/00

(52) U.S. Cl. 248/519

(57) ABSTRACT

A reversibly addable, puzzle-like interface IV pole weight assembly for use in stabilizing medical equipment stands (IV poles and similar structures, in particular). The apparatus is designed to be added and removed from an existing IV pole on an as-needed basis for altering the center of gravity of a pole/equipment combination so as to resist over-turn tendencies of the combination without the added weight assembly.

### BACKGROUND OF THE INVENTION

1. Field of the Invention

The present invention relates to medical equipment, and optional weights for stabilizing equipment and structures.

2. Background Information

Medical professionals and institutions operate under the ever-present threat of litigation in a large number of contexts—alleged mis-diagnosis, mis-treatment, infection, ineffective consent to treatment, and so on. Little do they need additional risks to patients and/or expensive medical equipment.

Wheeled, upright posts (“IV poles”) are used in hospitals, especially in the operating room and recovery rooms, for a wide variety of functions, other than simply to support intravenous bags (“IVs”). For example, various monitors and other pieces of equipment are often clamped to IV poles. Often, such equipment is positioned at such a height that the center of gravity is dangerously high, and accidents can result.

Despite their widespread use for supporting weighty equipment as just described, IV poles are not designed to avoid tipping over when so used. The combined IV poles and equipment become “top heavy” and simply fall over in far too many cases.

The risks associated with an equipment-laden IV pole falling over are, perhaps, greater than would be apparent to the casual observer. In whatever context they are used, IV poles are usually very close to the doctors and staff during surgery and patient care. There are many instances where it is far too easy to tip over a close-by IV pole. The consequences of this include violently pulling IV needles from patients, destroying costly equipment, losing vital functionality of the destroyed equipment, shock to the patient, staff and nearby patients from the associated noise, slip and fall risk because of spilled fluids, and even disease propagation if bodily fluids are dispersed in the violent episode.

One might suggest that simply making all IV poles “bottom heavy” would be the solution. But this ignores the fact that IV poles are not always (or even the majority of the time) used to support heavy equipment. So, having IV poles with permanent, heavy bases would be to render them unnecessarily cumbersome in many of their use contexts. Furthermore, having separate poles for IV bag and equipment support functions would simply multiply equipment inventory and associated expense.

In view of the above, it would well serve those in the medical services industry to provide some means by which an IV pole can be reversibly adapted to safely support weighty equipment by appropriately changing the center of gravity of the combined IV pole and mounted equipment.

Such a solution to the above-described problems would ideally be one which is easily attached and removed, is cost effective to make and purchase, and is durable.

### SUMMARY OF THE INVENTION

In view of the above, it is an object of the present invention to provide a solution to the problem of top-heavy IV poles and the associated risks of toppling over.

It is another object of the present invention to provide an apparatus for adjusting the center of gravity of an IV pole toward its base.

It is another object of the present invention to provide an apparatus for adjusting the center of gravity of an IV pole toward its base, which apparatus is easily added and removed from an existing IV pole.

In satisfaction of these and related objects, the present invention provides a reversibly addable, puzzle-like IV pole weight assembly for use in stabilizing medical equipment stands (IV poles and similar structures, in particular). The apparatus is designed to be added and removed from an existing IV pole on an as-needed basis.

The design of the preferred embodiment of the present invention is such that there are no sharp or protruding surfaces nor latches or mechanical devices which can fail or harbor infectious agents. Use of the apparatus is extremely simple, both for adding and removing the same from an IV pole.

The simplicity of the apparatus contributes, not only to its ease of use, but to its ease of production, and associated reasonable cost of acquisition.

The apparatus obviates the need for purchasing supports over IV poles already in-stock in order to safely support the various medical equipment now often unsafely mounted on standard IV poles.

The present invention also encompasses an IV pole which includes the weight apparatus at the inception.

### BRIEF DESCRIPTION OF THE DRAWINGS

FIG. 1 is a top plan, schematic view of the IV pole weight of the present invention, depicting the two halves of the preferred embodiment in their mated configuration such as during use of the apparatus.

FIG. 2 is a perspective view of an alternative embodiment of the present invention shown in-use on a standard IV pole.

FIG. 3 is a perspective view of the two halves of the alternative embodiment of FIG. 2, shown in a dis-engaged configuration, such as before attachment to an IV pole.

### DETAILED DESCRIPTION OF THE PREFERRED EMBODIMENT

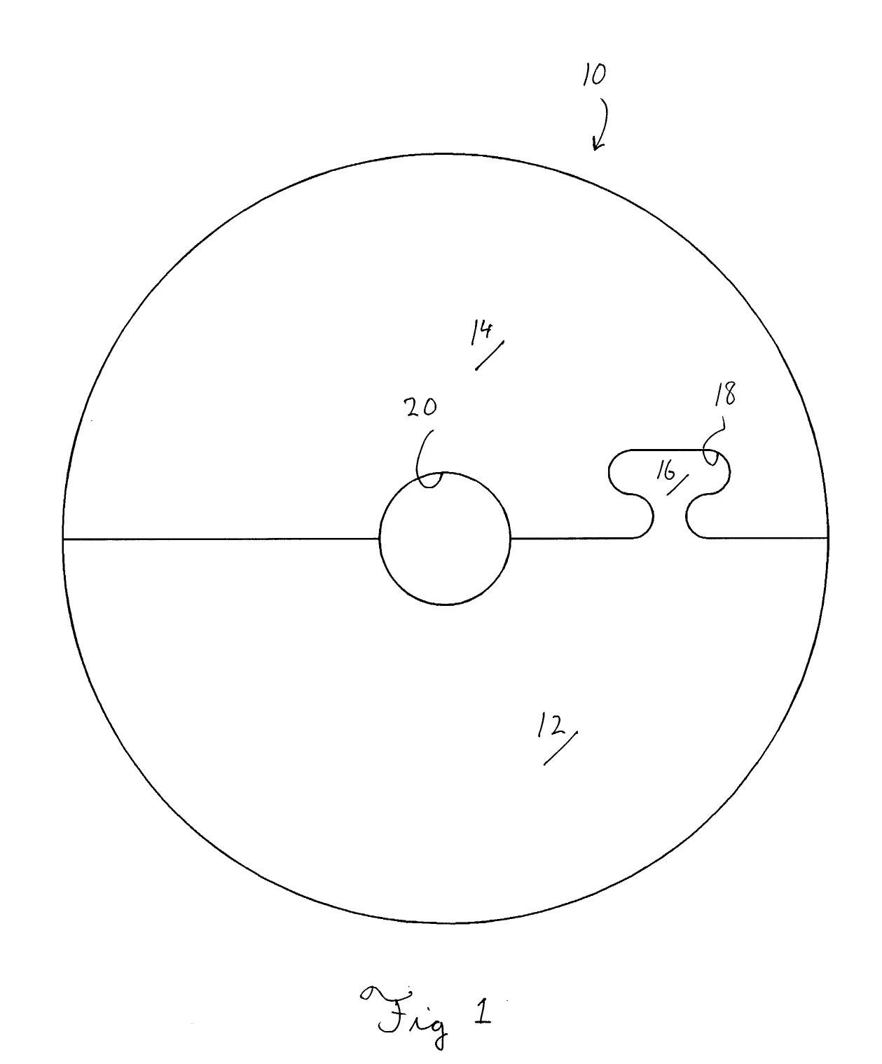

Referring to FIG. 1, the IV pole weight device of the present invention is identified generally by the reference number 10. Apparatus 10 is, in the preferred embodiment, a donut-shaped member comprising two halves—male member 12 and female member 14.

Male member 12 includes a contoured lobe (“projecting lobe”) 16 and female member 14 includes a contoured recess (“lobe-receiving recess”) 18. Lobe 16 and recess 18 are respectively positioned on male member 12 and female member 14 such that lobe 16 lodges within recess 18 in puzzle-like fashion, and such that, when lobe 16 and recess 18 are so interfaced, male member 12 and female member 14 define a substantially circular, disc-like over-all configuration, with a center hole 20 through which the pole portion of an IV pole or stand (not shown in FIG. 1) may pass during use. Center hole 20 is, of course, formed by complimentary semi-circular recesses in each of male member 12 and female member 14 as depicted in the drawings.

Lobe 16 and recess 18 may, of course, exhibit shapes other than that shown in FIG. 1, however any preferred embodiment will involve shapes which, not only mechanically engage male member 12 and female member 14 as against substantially anything but intentional disengagement (by sliding one of the two halves along the longitudinal axis of center hole 20), but will also prevent relative rotation of one halve vis a vis the other. It will be clear to anyone of reasonable mechanical expertise that the configuration shown in FIG. 1 fulfills these needs.

Male member 12 and female member 14 are, in the preferred embodiment, fashioned of steel. However, other metals, including lead or plastic encased concrete or aggregate, may be used. However, substantially smooth steel is preferred because of its substantial lack of properties which would harbor infectious agents as against routine cleaning techniques. Both for aesthetic purposes, and to prevent rusting, preferred embodiments of apparatus 10 are painted or powder coated.

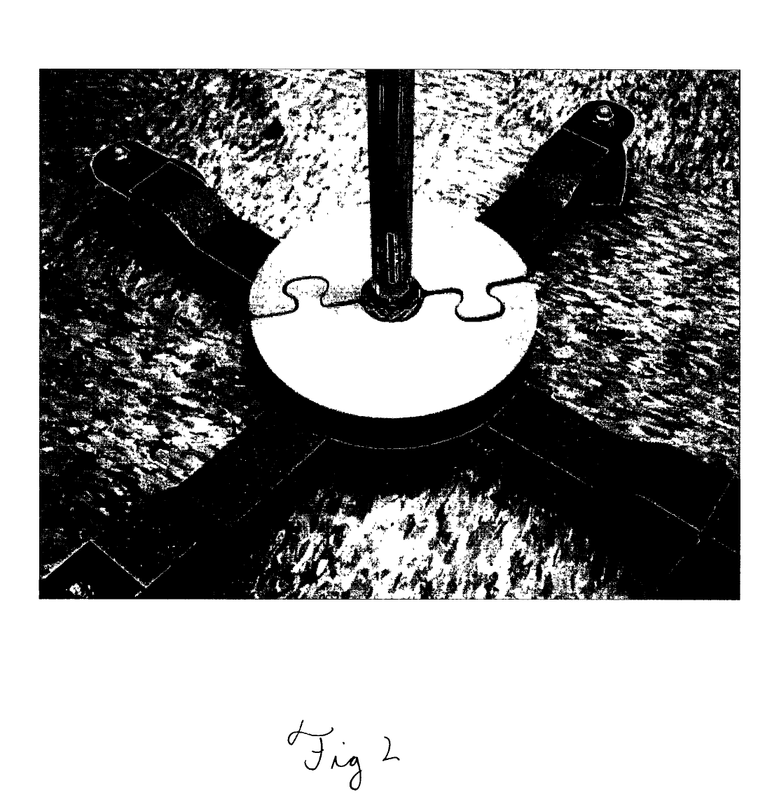

The preferred embodiment of apparatus 10 is 15 pounds (slightly over 7.5 pounds for male member 12, and slightly less than 7.5 pounds for female member 14). In its engaged configuration (with male member 12 and female member 14 interfaced as depicted in FIG. 1), apparatus 10 is 7.5″ in diameter, and is cut from 1.25″ thick steel plate. The inside diameter of center hole 20 is 1.5″. A rubber grommet (visible only in the view of an alternative embodiment in FIG. 2) is used placed in center hole 20 to help immobilize apparatus 10 as against vibration, etc. vis a vis an IV pole, and also to mitigate differences in diameters of various models of IV poles with which apparatus 10 will be used.

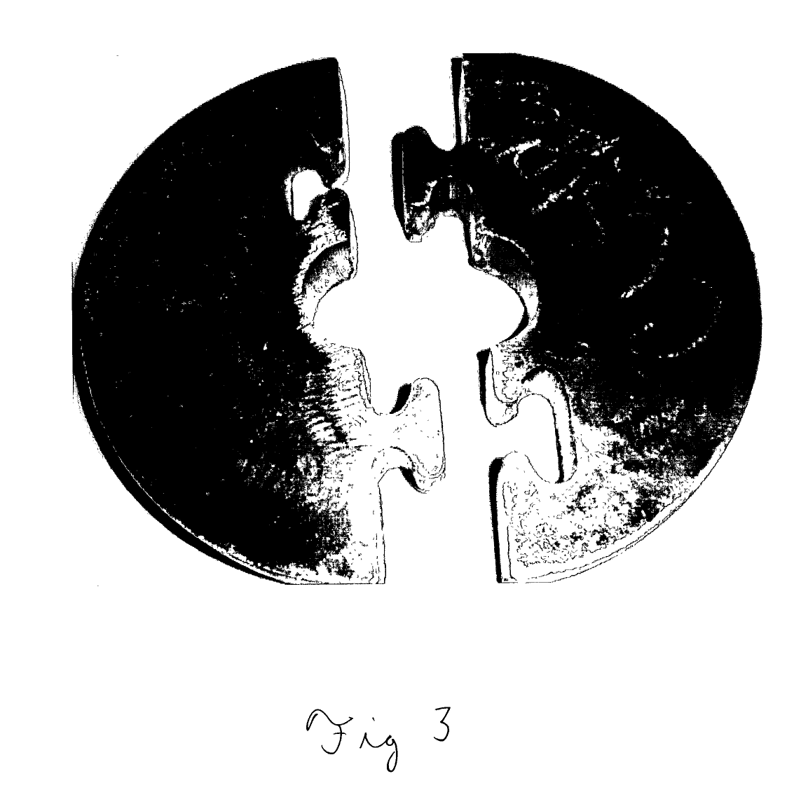

Referring to FIGS. 2 and 3, an alternative embodiment of the present invention is disclosed. This embodiment includes dual male lobes and female lobes, one on each apparatus half. While the embodiment shown in FIG. 1 is preferred, because it is believed to be the simplest to use, some users may perceive an embodiment with multiple interface sites, such as shown in FIGS. 2 and 3, to somehow be more stable. Certainly, such an alternative embodiment would fall within the scope of the present invention.

Whatever embodiment of the present invention is used, by adding weight to one of the lowest points on an IV pole, an apparatus of the present invention lowers the center of gravity of an IV pole and equipment combination, thus stabilizing the pole and making it less susceptible to tipping.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An assembly for stabilizing medical equipment supports comprising:
a first weight member which includes a projecting lobe member;
a second weight member which includes a lobe-receiving recess, contoured for receiving said projecting lobe member in a puzzle-like interface;
said first weight member and said second weight member each having formed therein a substantially semicircular recess;
said first weight member and said second weight member being configured whereby, when said projecting lobe member and said lobe-receiving recess are interfaced, said semi-circular recesses of each said weight member define a single, substantially circular opening substantially near the center of the combined first and second weight members.
